(19) United States
(12) Patent Application Publication
(10) Pub. No.: US 2017/0267507 A1
(43) Pub. Date: Sep. 21, 2017

(54) Foot Guard for Lift

(71) Applicant: William F. Frame, Coatesville, PA (US)

(72) Inventor: William F. Frame, Coatesville, PA (US)

(21) Appl. No.: 15/453,694

(22) Filed: Mar. 8, 2017

Related U.S. Application Data
(60) Provisional application No. 62/305,474, filed on Mar. 8, 2016.

(51) Int. Cl. B66F 17/00; B60R 19/54

(52) U.S. Cl. CPC B66F 17/006; B60R 19/54; B60R 2019/002

(57) ABSTRACT

A foot guard for a lift and a lift having a foot guard. The lift having a base having a top surface and wheels. The foot guard extends around a periphery of the base and extends from the top surface of the base of the lift to a floor. The foot guard covers the wheels of the base. The foot guard includes a top wall and a vertical side wall. An underside of the top wall engages with the top surface of the base.

### CROSS-REFERENCE TO RELATED APPLICATIONS

This application cams priority to U.S. Provisional Pat. Application 62/305,474 filed on Mar. 8, 2016.

### STATEMENT REGARDING FEDERALLY SPONSORED RESEARCH OR DEVELOPMENT

The present invention was not developed with the use of any Federal Funds, but was developed independently by the inventor.

### BACKGROUND

Field

The Invention pertains to lifts, and more specifically to a foot guard for a lift.

### SUMMARY

A foot guard for a lift and a lift having a foot guard. The lift having a base having a top surface and wheels. The foot guard extends around a periphery of the base and extends from the top surface of the base of the lift to a floor. The foot guard covers the wheels of the base. The foot guard includes a top wall and a vertical side wall. An underside of the top wall engages with the top surface of the base.

The foot guard may further include a protruding lip that extends around the vertical side wall of the foot guard. The foot guard may further include a medial wall which connects the top wall and the vertical side wall, the medial wall is beveled or rounded. The foot guard may be substantially vertical with respect to the floor. The foot guard may follow a contour of the lift base.

The foot guard may further include a cut-out portion in a medial portion of a side wall to expose a controller of the lift mounted on the base of the lift.

### BRIEF DESCRIPTION OF THE DRAWINGS

The embodiments will be described in detail with reference to the following drawings in which like reference numerals refer to like elements wherein:

FIG. 1 shows an isometric top view of an existing lift.

FIG. 2 shows an isometric bottom view of an existing lift.

FIG. 3 shows an isometric top view of a lift having a foot guard in accordance with the present invention

FIG. 4 shows an isometric bottom view of the lift of FIG. 3.

FIG. 5 shows a top view of the lift of FIG. 3.

FIG. 6 shows a bottom view of the lift of FIG. 3.

FIG. 7 shows an isometric top view of the foot guard of the lift of FIG. 3.

FIG. 8 shows an isometric top view of the foot guard of the lift of FIG. 3.

FIG. 9 shows a top view of the foot guard of the lift of FIG. 3.

FIG. 10 shows a cross sectional view of t e foot guard along lines 10-10 of FIG. 10.

FIG. 11 shows a rosy sectional of the foot guard along lines 11-11 of FIG. 10.

FIG. 12 shows a cross sectional view of the foot guard along lines 12-12 of FIG. 10.

FIG. 13 shows a cross sectional view of the toot guard along lines 13-13 of FIG. 10.

### DETAILED DESCRIPTION

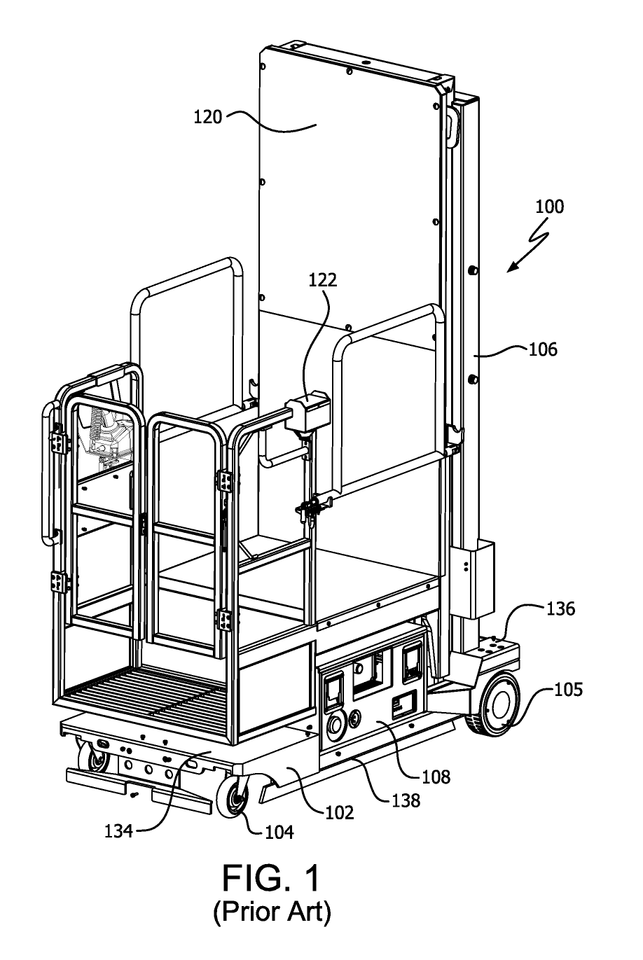

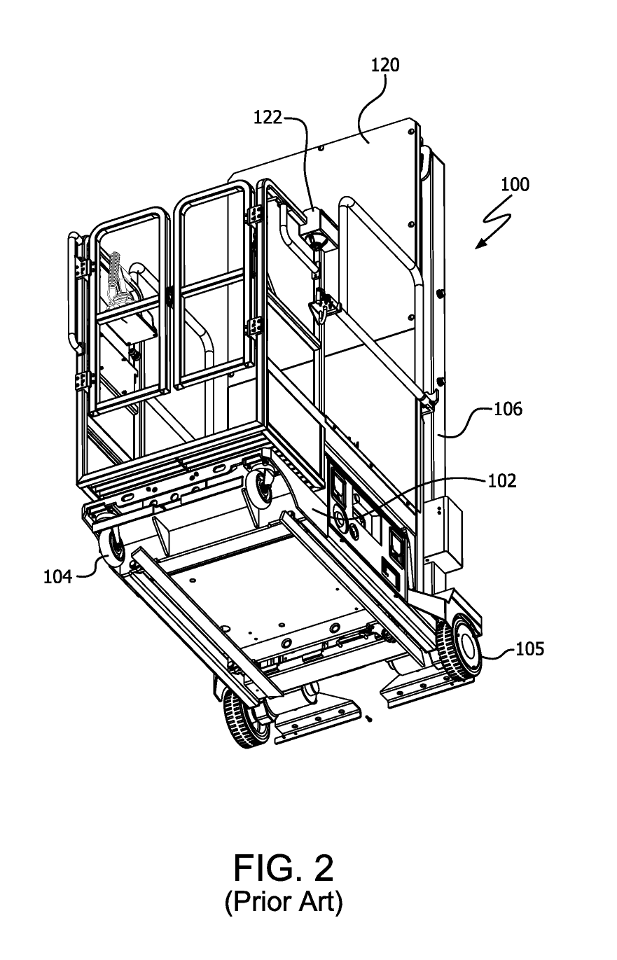

FIGS. 1 and 2 show an existing lift device 100. The lift 100 typically includes a chassis or base 102 mounted on front wheels 104 and rear wheels 105 which provide mobility for the lift 100, a vertical telescoping lift boom or lift assembly 106 extends upward from the base 102 a drive system and controller 108 mounted to the base 102, a vertically movable platform 120 which travels up with the lift assembly 106 and also includes lift controls 122. The base 102 includes a front planar base portion 134, a rear planar base portion 136, and side board portions 138 which connect the front planar base portion 134 and the rear planar base portion 136.

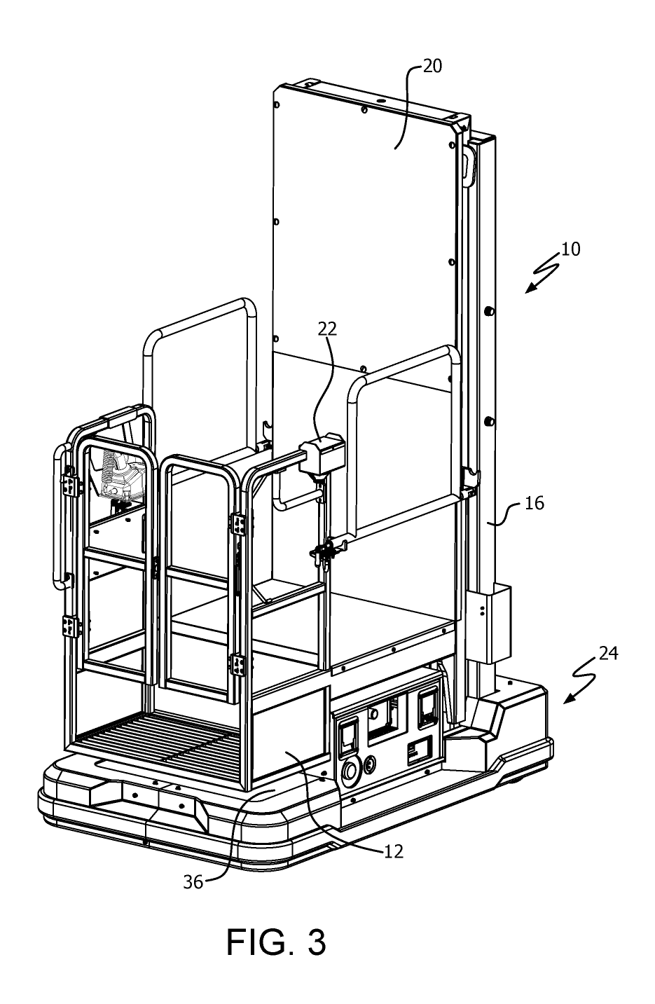

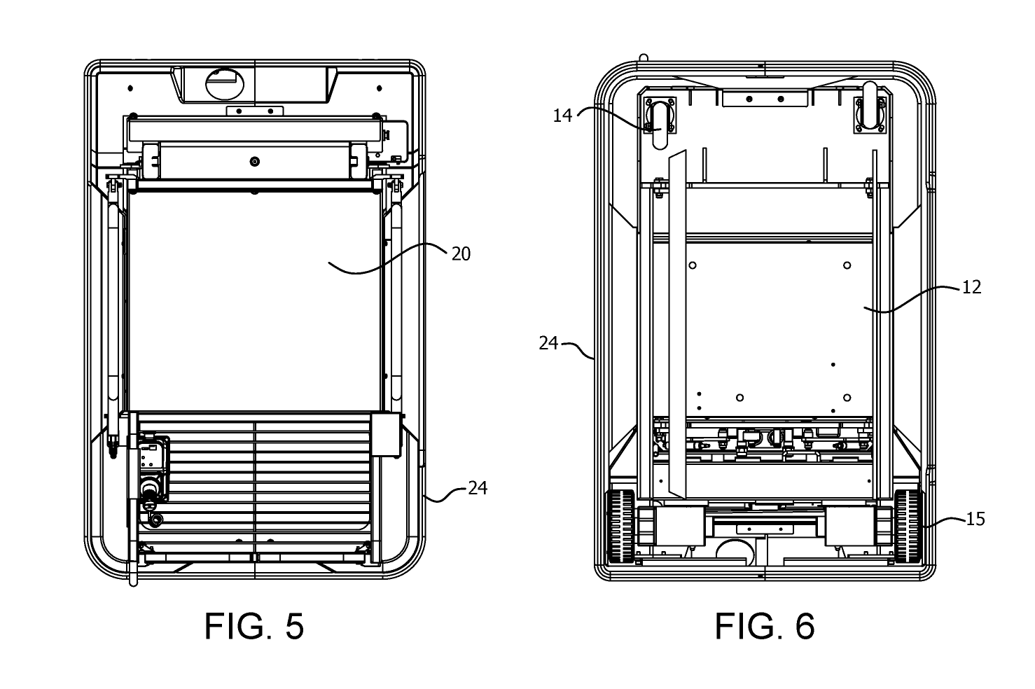

Turning now to FIGS. 3-6, the figures show a lift 10 in accordance with the present invention. The lift 10 includes a chassis or base 12 mounted on front wheels 14 and rear wheels 15 which provide mobility for the lift 10, a vertical telescoping lift boom or lift assembly 16 extends upward from the base 12, a drive system and controller 18 mounted to the base 12, a vertically movable platform 20 which travels up with the lift assembly 16 and also includes lift controls 22. The base 12 includes a front planar base portion 34, a rear planar base portion 36, and side board portions 38 which connect the front planar base portion 34 and the rear planar base portion 36.

The base 12 defines a top surface 20. The movable platform 20 is provided above the base 12 and travels up with the lift portion 16.

A foot guard 24 is provided around the periphery of the base 12 as shown in FIGS. 3-6. The foot guard 24 extends around the periphery of the base 12 and extends from the bottom of the base 12 of the lift to the floor.

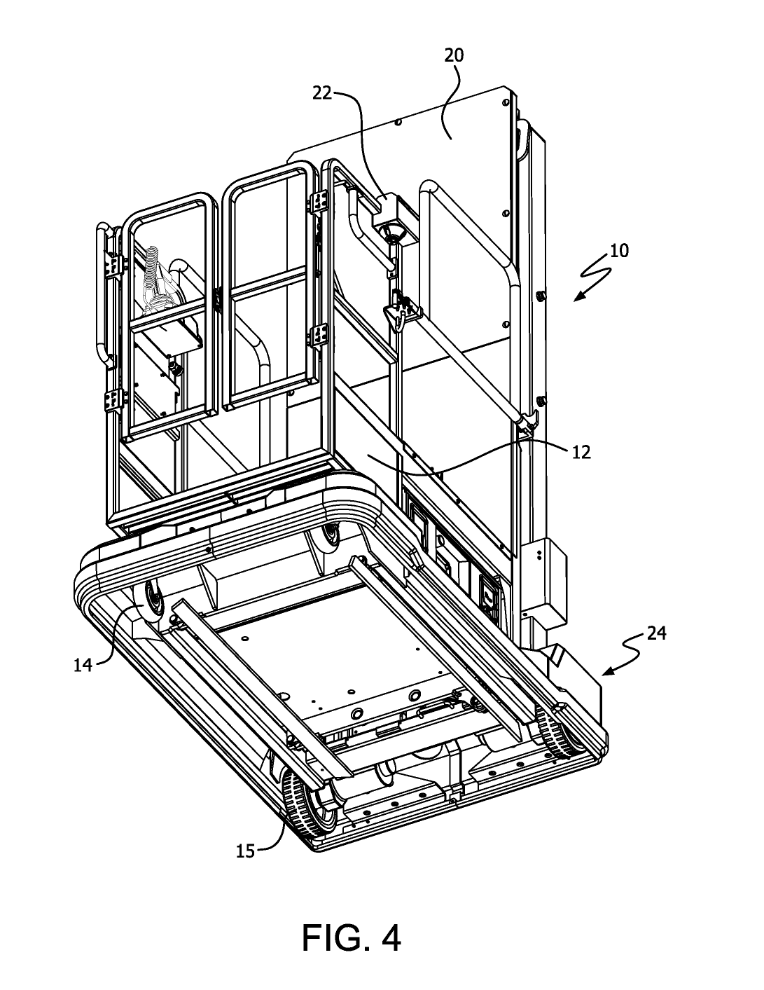

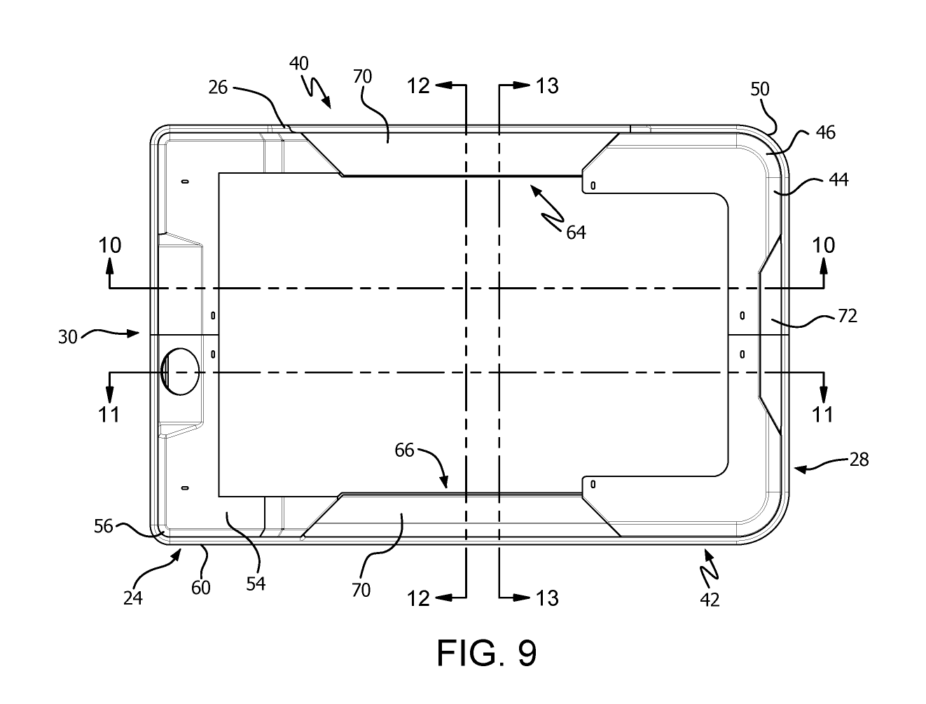

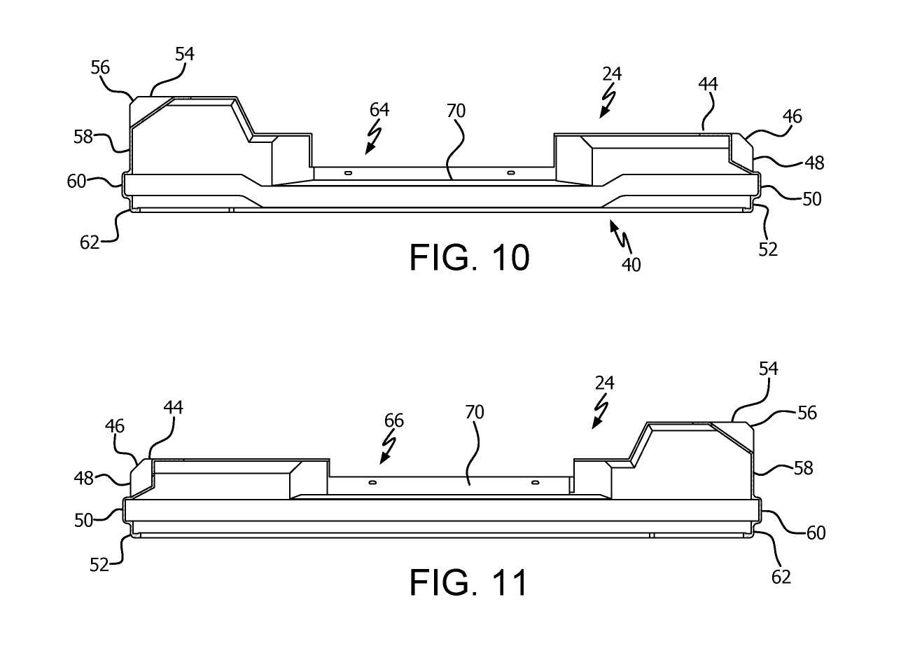

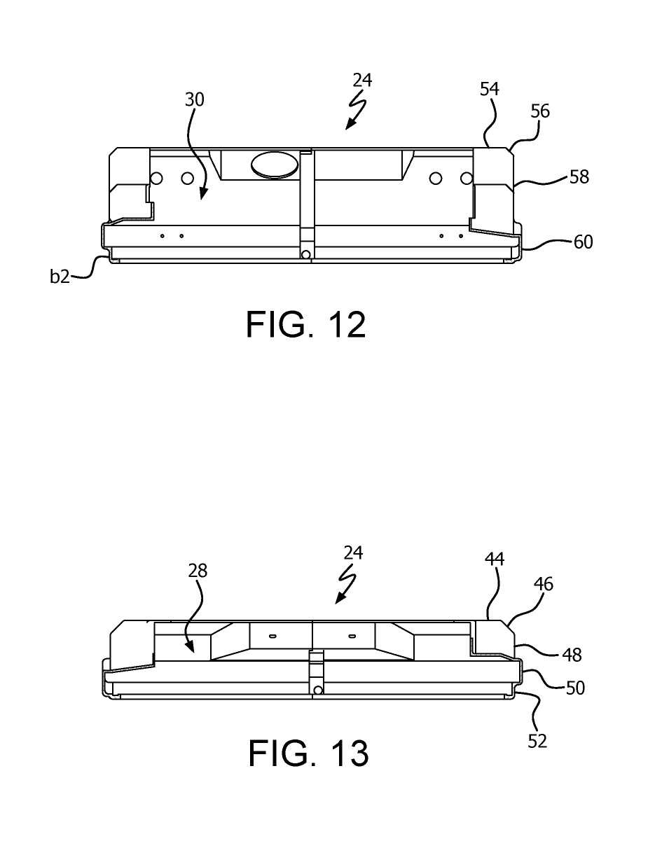

Referring now to FIGS. 8-13, the foot guard 24 is shown in isolation. The foot guard 24 may further comprise a side wall 26, a front wall 28, a back wall 30 and an other side wall 32. The foot guard 24 may be substantially vertical with respect to the floor. In one form of the invention, the foot guard 24 comprises a right half 40 and a left halt 42 which are joined around the periphery of the base 12 of the lift 10 (as best seen in FIGS. 3 and 4). The two halves 40 and 42 of the foot guard 24 are fastened to the lift base 12 using suitable fasteners (not shown)

The foot guard 10 includes a front top wall 44 the underside of which engages with the top of the front planar base portion 34. A beveled medial wall 46 extends from the front top wall 44 and connects with a vertical front wall 48. A beveled protruding lip 50 extends around the foot guard 44 below the vertical front wall 50. A lower front vertical wall 52 is below the lip 50.

The foot guard 10 includes a rear top wall 54 the underside of which engages with the top of the rear planar base portion 36. A beveled medial wall 56 extends from the front top wall 54 and connects with a vertical front wall 58. A beveled protruding lip extends around the foot guard 54 below the vertical front wall 60. A lower front vertical wall 62 is below the lip 60.

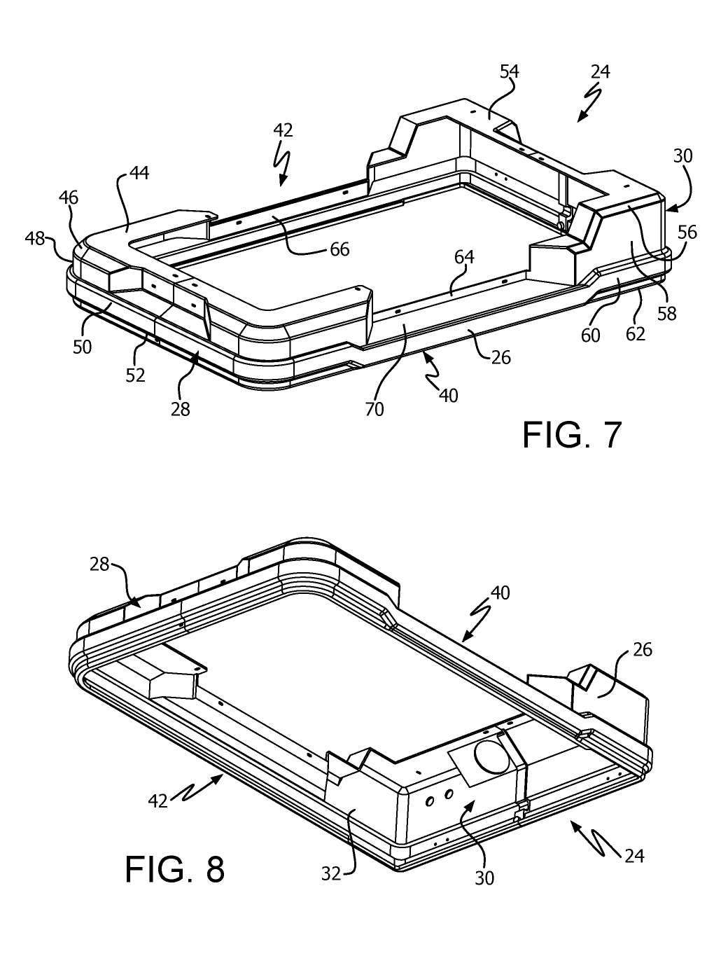

A pair of cut-out portions 64 and 66 are provided on the side walls 40 and 42 respectively to provide access to the controller 18. A planar horizontal medial surface 70 is also provided in the side walls 40 and 42. And a planar horizontal medial surface 72 is provided In the front wall 28 of the foot guard 28. As best seen in FIG. 3 and FIG. 7, the foot guard 24 is contoured to match the contour of the base portion 12 of the lift 10.

The foot guard 22 may have an outer face 30. The foot guard 22 shape may be flat, faceted, curved, or any other suitable shape.

The purpose of the guard 24 is to prevent a user's foot from being rolled over by the lift wheels 14 and 15 and to keep a person's foot from going under the lift 10 and the lift structure striking the lower leg and potentially causing injury. The guard 24 may have faceted surfaces, as shown, rounded surfaces or any other suitable shape.

Another advantage of the foot guard design is to help enforce proper clearance between shelving and the lift 10 to help prevent the lift platform 20 from catching on the shelving while raising and lowering and to help prevent the lift base 12 from catching on objects while driving (due to the continuous and smooth nature of its outline).

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A foot guard for a lift, the lift having a base having a top surface and wheels, the foot guard comprising:
a foot guard that extends around a periphery of the base and extends from the top surface of the base of the lift to a floor, the feet guard covers the wheels of the base, the foot guard comprises a top wall and a vertical side wall, an underside of the top wall engages, with the top surface of the base.

2. The foot guard in accordance with claim 1 wherein the foot guard further comprises a protruding lip that extends around the vertical side wall of the foot guard.

3. The foot guard in accordance with claim 1 wherein the foot guard further comprises a medial wall which connects the top wall and the vertical side wall, the medial wall is beveled or rounded.

4. The foot guard in accordance with claim 3 wherein the foot guard further comprises a protruding lip that extends around the vertical side wall of the foot guard.

5. The foot guard in accordance with claim 1 wherein the foot guard is substantially vertical with respect to the floor.

6. The foot guard in accordance with claim 4 wherein the foot guard is substantially vertical with respect to the floor.

7. The foot guard in accordance with claim 1 wherein the foot guard follows a contour of the lift base.

8. The foot guard in accordance with claim 6 wherein the foot guard follows a contour of the lift base.

9. The foot guard in accordance with claim 1 wherein the foot guard further comprises a cut-out portion in a medial portion of a side wall to expose a controller of the lift mounted on the base of the lift.

10. The foot guard in accordance with claim 8 wherein the foot guard further comprises a cut-out portion in a medial portion of a side wall to expose a controller of the lift mounted on the base of the lift.

11. A lift, the lift having a base, the lift comprising: A foot guard for a lift, the lift having a base having a top surface and wheels, the foot guard comprising:
a lift having a base having a top surface and wheels; and
a foot guard that extends around a periphery of the base and extends from the top surface of the base of the lift to a floor, the foot guard covers the wheels of the base, the foot guard comprises a top wall and a vertical side wall, an underside of the top wall engages with the top surface of the base.

12. The lift in accordance with claim 11 wherein the foot guard further comprises a protruding lip that extends around the vertical side wall of the foot guard.

13. The lift in accordance with claim 11 wherein the foot guard further comprises a medial wall which connects the top wall and the vertical side wall, the medial wall is beveled or rounded.

14. The lift in accordance with claim 13 wherein the foot guard further comprises protruding lip that extends around the vertical side wall of the foot guard.

15. The lift in accordance with claim 11 wherein the foot guard is substantially vertical with respect to the floor.

16. The lift in accordance with claim 14 wherein the foot guard is substantially vertical with respect to the floor.

17. The lift in accordance with claim 1 wherein the foot guard follows a contour of the lift base.

18. The lift in accordance with claim 16 wherein the foot guard follows a contour of the lift base.

19. The lift in accordance with claim 11 wherein the foot guard further comprises a cut-out portion in a medial portion of a side wail to expose a controller of the lift mounted on the base of the lift.

20. The lift in accordance with claim 18 wherein the foot guard further comprises a cut-out portion in a medial portion of a side wall to expose a controller of the lift mounted on the base of the lift.
